(19) United States
(12) Patent Application Publication
(10) Pub. No.: US 2008/0078111 A1
(43) Pub. Date: Apr. 3, 2008

(54) Business placard

(76) Inventors: Andy Kaoh, Taipei Hsien (TW); Shieh-Hwei Lee Chen, Taipei Hsien (TW)

Correspondence Address: ANDY KAOH, 235 Chung-Ho, Box 8-24, Taipei, omitted

(21) Appl. No.: 11/542,011

(22) Filed: Oct. 2, 2006

(51) Int. Cl. G09F 13/28

(52) U.S. Cl. 40/550

(57) ABSTRACT

A business placard comprises: an acrylic panel having a U shape cross section; a lower end of each of two lateral sides of the acrylic panel being protruded downwards with connecting block; a back plate made of acrylonitrile-butadience styrene plastics; each end of two lateral sides of the back plate having a reduced section corresponding to the reduced section of the acrylic panel; and a light source placed within the back plate. In assembly, the reduced section of the acrylic panel is combined to the reduced section of the back plate by melting the connecting block using supersonic technology.

### FIELD OF THE INVENTION

The present invention relates to placards, and particularly to a business placard which comprises an acrylic panel having a U shape cross section; a lower end of each of two lateral sides of the acrylic panel is protruded downwards with connecting block; a back plate made of acrylonitrile-butadience styrene plastics; each end of two lateral sides of the back plate having a reduced section corresponding to the reduced section of the acrylic panel; and a light source placed within the back plate. In assembly, the reduced section 6f the acrylic panel is combined to the reduced section of the back plate by melting the connecting block using supersonic technology.

### BACKGROUND OF THE INVENTION

Referring to FIGS. 1 and 2, the prior art placard is illustrated. In the prior art, an acrylonitrile-butadience styrene plastics casing 1 is locked with an acrylic panel 2 by screws. Light sources are placed in the casing 1. However, the assembly of this prior art has screw holes on the surface of the panel so as to present an unbeautiful outlook. Furthermore for a long time, the screws will rusted so as to weaken the structure, even the placard will fall down.

### SUMMARY OF THE INVENTION

Accordingly, the primary object of the present invention is to provide a business placard, wherein no screw and screw hole are used so that the product has a beautiful outlook. Thereby the cost is low and thus it can be produced rapidly. Moreover, the connection of the acrylic panel and back plate can be performed easily.

To achieve above objects, the present invention provides a business placard, comprising: an acrylic panel having a U shape cross section; a lower end of each of two lateral sides of the acrylic panel is protruded downwards with connecting block; a back plate made of acrylonitrile-butadience styrene plastics; each end of two lateral sides of the back plate having a reduced section corresponding to the reduced section of the acrylic panel; and a light source placed within the back plate. In assembly, the reduced section of the acrylic panel is combined to the reduced section of the back plate by melting the connecting block using supersonic technology.

The various objects and advantages of the present invention will be more readily understood from the following detailed description when read in conjunction with the appended drawing.

### BRIEF DESCRIPTION OF THE DRAWINGS

FIG. 1 is a cross sectional view about the prior art placard.

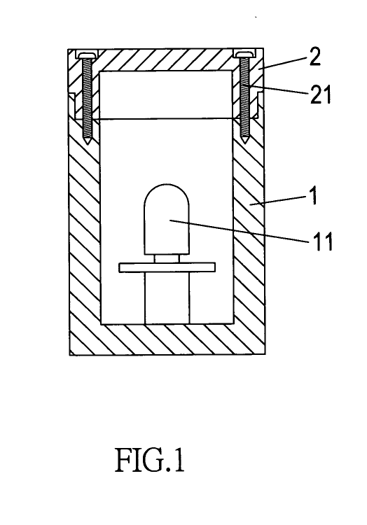

FIG. 2 is a perspective view of the prior art placard.

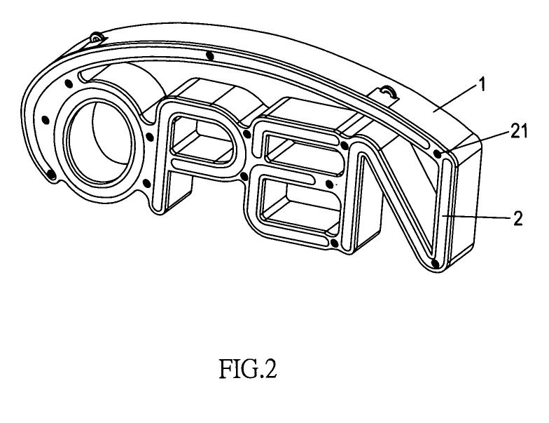

FIG. 3 is a cross sectional view about the business placard of the present invention.

FIG. 4 is another cross sectional view about the business placard of the present invention.

FIG. 5 is a structural exploded view about the business placard of the present invention.

FIG. 6 is a structural perspective view about the business placard of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

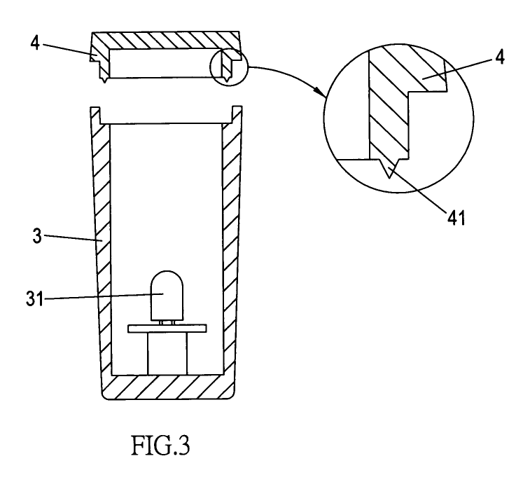

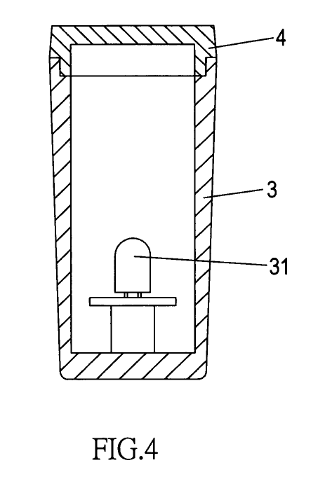

Referring to FIGS. 3 and 4, the placard of the present invention is illustrated. The present invention has the following elements.

An acrylic panel 4 has a U shape cross section. A lower end of each of two lateral sides of the acrylic panel 4 is protruded downwards with connecting block 41.

A back plate 3 made of acrylonitrile-butadience styrene plastics is included. Each end of two lateral sides of the back plate 3 has a reduced section corresponding to the reduced section of the acrylic panel.

A light source 31 is placed within the back plate 3.

In assembly, the reduced section of the acrylic panel 4 is combined to the reduced section of the back plate 3 by melting the connecting block 41 using supersonic technology.

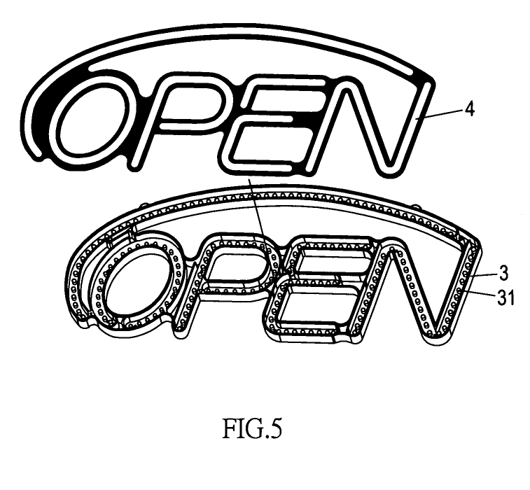

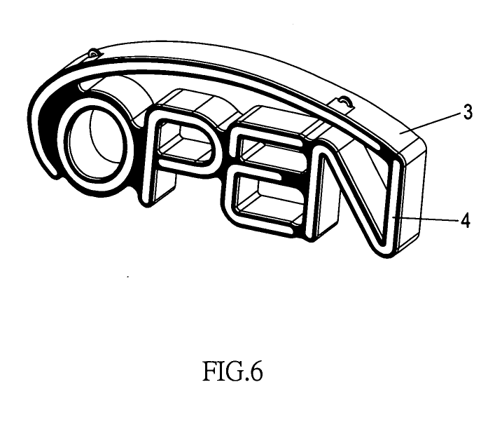

With reference to FIGS. 5 and 6, it is illustrated that the acrylic panel 3 and back plate 4 made of acrylonitrile-butadience styrene plastics can be formed as a pattern. In assembly, the reduced section of the acrylic panel 4 is combined to the reduced section of the back plate 3 by melting the connecting block 41 using supersonic technology.

Advantages of the present invention are that no screw and screw hole are used so that the product has a beautiful outlook. Thereby the cost is low and thus it can be produced rapidly. Moreover, the connection of the acrylic panel and back plate can be performed easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What claimed is:

1. A business placard, comprising:
an acrylic panel having a U shape cross section; a lower end of each of two lateral sides of the acrylic panel being protruded downwards with connecting block;
a back plate made of acrylonitrile-butadience styrene plastics; each end of two lateral sides of the back plate having a reduced section corresponding to the reduced section of the acrylic panel; and
a light source placed within the back plate;
wherein in assembly, the reduced section of the acrylic panel is combined to the reduced section of the back plate by melting the connecting block using supersonic technology.
